(19) United States
(12) Patent Application Publication
(10) Pub. No.: US 2010/0299194 A1
(43) Pub. Date: Nov. 25, 2010

(54) SYSTEMS AND METHODS FOR IMPLEMENTING AND MANAGING GIFT CARDS

(76) Inventors: Glenn A. Snyder, Sudbury, MA (US); David D. Stone, Falmouth, ME (US); Phelps Alan Peeler, Portland, ME (US)

Correspondence Address: LANDO & ANASTASI, LLP, ONE MAIN STREET, SUITE 1100, CAMBRIDGE, MA, 02142, US

(21) Appl. No.: 12/470,802

(22) Filed: May 22, 2009

(51) Int. Cl. G06Q 30/00; G06Q 20/00

(52) U.S. Cl. 705/14.13; 705/14.23; 705/14.25; 705/26; 705/39

(57) ABSTRACT

An offer management system is provided that evaluates conditions in relation to a gift card and triggers an action. In another example, the offer management system may be capable of evaluating attributes of a transaction using a gift card and may be capable of triggering an action. A trigger may be defined using one or more rules. For example, an administrator for a retailer may configure an offer rule in an interface of the offer management system. These rules may be evaluated in real-time, and offers made responsive to those evaluations. For example, offers may be made to a gift card recipient such as a discount on the total purchase, a dynamic addition of value to a gift card, issuance of a new gift card, or other offer. These offers may be used by a retailer to foster certain behaviors relating to gift cards.

### APPLICABLE FIELD

The field of the present invention relates generally to systems and methods for implementing and managing gift cards.

### BACKGROUND

Some retailers have implemented gift card programs where a visitor to a retail establishment can purchase a card of a particular denomination. The card may then be given to a recipient, who can redeem the gift card at the retail establishment for the specified denomination. There are also computer-based systems that allow a visitor to a website to purchase a “virtual” gift card which can be distributed electronically to a recipient (e.g., via email or other distribution method).

### SUMMARY

Described herein are systems and methods for implementing and managing gift card programs. Gift card programs may include the conventional purchase and giving of physical gift cards, or more recent implementations of virtual gift cards. Broadly speaking, a virtual gift card is an electronic implementation of the physical gift cards that can be purchased in many retail establishments and redeemed by gift card recipients for the purchase of goods and/or services. The virtual gift card may be purchased and/or redeemed in physical storefronts, on-line (either at a retailer's website or a third-party website), in catalogs, by telephone, by mail, or in any other way that transactions for the sale of goods or services are carried out. The virtual gift card may be redeemable for goods or services such as retail goods, purchases in restaurants, travel services, hotel or other hospitality services, entertainment such as movie tickets, or any other goods or services. The term “retailer” is used herein to describe an entity that accepts payment for goods or services by virtual gift card, but it should be understood that the “retailer” in the following discussion can be any provider of goods or services including, but not limited to manufacturers or products, providers of services, resellers, advertisers, or other type of provider.

According to various embodiments, an offer management system is provided that may be implemented with a gift card program. In particular, an offer management system may be provided that permits retailers to reach consumers that purchase or receive gift cards. In one embodiment, the offer management system permits an association of an “offer” or “promotion” with a prepaid device (e.g., a physical or virtual gift card). The offer management system may include controls that permit an administrator (e.g., the gift card issuer, retailer, advertiser, or other entity) to define conditions that, if met, cause an offer to be triggered. An administrator may be, for instance, a person who is authorized to create and manage offers on behalf of a retailer or affiliate organization.

Further, configuration controls may be provided that allow an administrator to determine rules that define when an offer/promotion should be associated with a newly created prepaid device. For instance, a rule may be defined that only associates particular offers with devices issued in a specific date window, devices purchased at a particular physical/virtual location, gift cards associated with a particular retailer, or other parameters. When the conditions surrounding the purchase or use of the prepaid device match the rule-based conditions of the offer or promotion, the offer management system triggers the fulfillment of the offer or promotion.

According to various embodiments, an offer management system may be provided that evaluates the conditions at point of purchase (e.g. the referrer at point of purchase, a promotion code, the cost of the purchase, the physical/virtual location of purchase, date on which the purchase is made, etc.) and trigger an action (e.g. issue of an additional prepaid instrument, discount on the purchase of the prepaid instrument, etc.). In another embodiment, the offer management system may be capable of evaluating attributes of a transaction (i.e., a total amount of the transaction, a location where the transaction occurred, date/time of the transaction, products purchased, cost of those products, etc.) and trigger an action (e.g. a discount on the total purchase, dynamic addition of value to the prepaid device, issuance of a new prepaid device, etc.).

According to one embodiment, conditions may be evaluated dynamically upon purchase or redemption of the gift card or at any point during the gift card's existence, and the offer may be fulfilled in real time. For instance, if a set of conditions are fulfilled when a gift card recipient redeems the gift card, the gift card recipient may receive additional value at the point of redemption. In one example, a merchant may add $10 of value to a $50 gift card if the recipient uses the gift card within two weeks. In another example, a merchant may offer a free $10 gift card to anyone who purchases a gift card worth $100 or more. The purchaser can decide to keep the gift card for him or herself or can add the value to the recipient's gift card.

Also, according to other embodiments, offers may be triggered based on actions taken with respect to the gift card. For instance, when the gift card is purchased, an offer may be made to the purchaser and/or recipient of the gift card when particular conditions are met (e.g., for a purchaser of a particular gift card type having a value of $100 or more, provide a coupon for a free ski lift ticket at a particular ski resort). In another example, the recipient of a gift card may be encouraged to provide additional information about themselves to receive additional offers. For instance, if the recipient of the gift card registers his/her personal information, that recipient may be provided an offer by the offer management system. Also, that offer may be determined based on the additional information provided such as location of the recipient, demographic information, or other information.

According to another embodiment, because the action taken with respect to the gift card can be tracked, offers can be made that influence gift card use and behavior. For instance, a particular retailer may create an offer that provides some type of offer to the first 100 or other number of people that perform an action with respect to the gift card. In one example, the first 100 people that use the gift card in excess of $100 get another prepaid gift card in the amount of $20 (e.g., physical or virtual). Also, because gift card use can be tracked, retailers can control how much the overall offer will cost the retailer. For instance, the retailer can track how many offers are extended in real time, and cut off the offer when the total amount of the offer exceeds a certain amount. In one example, $10 prepaid gift cards may be offered to users of gift cards until the giveaway exceeds $10,000. Because a conventional gift card use (e.g., physical gift cards having a magnetic stripe) cannot be tracked in such a way, such types of offers were not possible.

Further, other types of instruments such as coupons may be used as a basis for an offer, and gift card and coupons may be used in various combinations. For instance, when a gift card is purchased, redeemed, etc., a coupon may be generated, and vice versa. A combination of coupons and prepaid instruments may be used.

Also, one or more tools may be provided to an administrator of a gift card program that permits the administrator to track offer programs. One advantage of tracking an offer program (e.g., offer amounts, redemption percentage, etc.) includes allowing the administrator to design and predict future outcomes of administered programs using stored business intelligence. According to one embodiment, an offer management system is provided that permits multiple providers to administer offer programs. Historical data from particular programs (from multiple providers) may be used to provide recommendations to a particular provider to administer a new offer program. In this way, performance data may be shared among providers, yet not permit unrestricted access to program information of other providers.

In other embodiments, the systems and methods described herein provide a comprehensive system that permits a retailer to rely on a third-party service for providing virtual gift cards while preserving its own branding in the design elements included in the interface provided to virtual gift card purchasers and recipients and in the virtual gift card itself. Instead of having to develop its own in-house system for administering the sale and redemption of gift cards, a retailer can engage a third party virtual gift card provider providing administration according to the methods and systems described herein, and obtain a set of tools for customizing virtual gift cards according to the retailer's branding and design requirements. Embodiments of the systems and methods described herein also allow purchasers to customize aspects of the virtual gift card, which can increase customer engagement resulting in more sales to the retailer. Moreover, in embodiments in which the virtual gift card interface includes branding and/or other design elements specific to the retailer, the experience of purchasing or redeeming a virtual gift card can be essentially transparent to the user. Instead of being redirected to an obvious third-party website, the user may be redirected to a provider website using the design elements of the familiar, trusted retailer, which can increase customer trust and willingness to purchase virtual gift cards.

Also provided in embodiments of the systems and methods described herein is a readily customizable system of on-line tools that the retailer can use to set up, configure, re-configure, and monitor a virtual gift card program. Instead of engaging an in-house or third party developer to develop tools for administering a virtual gift card program, a retailer can visit a provider's website and use the tools provided to quickly and easily set up a virtual gift card template with as much branding, as much specificity, and as many options for the purchaser as the retailer wishes. As described further below, the retailer can, in embodiments, have access to monitoring and analysis tools for studying sales and redemption data in real-time.

In embodiments of the present systems and methods, a virtual gift card purchaser buys a virtual gift card for a recipient. In embodiments, the virtual gift card is accepted for purchases by a particular retailer or group of retailers. An account (i.e., a database entry) may be created corresponding to the recipient's virtual gift card and credited with the virtual gift card amount selected and paid for by the purchaser. The recipient receives, for example in email or in a web browser, a notification of the virtual gift card. The notification may include a virtual gift card code uniquely correlated to the recipient's virtual gift card. The recipient may then make purchases on-line using the code, and the amount of such purchases will be debited from the recipient's virtual gift card. Alternatively, the recipient may print out an email or a web-page including the virtual gift card code or an encoded representation of the code (such as a bar code) and bring the printout to a physical storefront of a retailer accepting the virtual gift card. At the physical storefront the code may be keyed or scanned into a computer which requests a debit from the recipient's virtual gift card of the amount of purchase.

According to one aspect of the present invention, a method for administering a virtual gift card is provided. The method comprises acts of configuring, in an offer management system, one or more offer rules that define when an offer is presented to a user, associating the one or more offer rules with a gift card, and responsive to one or more actions by the user in relation to the gift card, the action triggering at least one of the one or more offer rules, extending an offer associated with the at least one of the one or more offer rules to the user. According to one embodiment of the present invention, the action comprises a purchaser purchasing the gift card. According to another embodiment of the invention, the offer is extended to the purchaser of the gift card. According to another embodiment of the invention, the offer is extended to a recipient of the gift card. According to another embodiment of the invention, the gift card is a virtual gift card, and wherein the offer management system interfaces with a virtual gift card management system. According to another embodiment of the invention, the action comprises a gift card recipient redeeming the gift card.

According to one embodiment of the present invention, the method further comprises acts of providing an interface to a terminal operated by a purchaser; the interface comprising fields for receiving a value and a recipient for the virtual gift card, receiving from the terminal, in response to input from the purchaser, the value and the recipient for the virtual gift card, generating a code for the virtual gift card, sending a message to the recipient of the virtual gift card, the message including the code for the virtual gift card, one or both of receiving, from a terminal operated by the recipient, a message including the code for the virtual gift card and an amount of a purchase, and receiving, from a terminal operated by the retailer, a message including the code for the virtual gift card and an amount of a purchase; and debiting, from an account associated with the recipient, the amount of the purchase. According to another embodiment of the invention, the extended offer relates to at least one of a physical gift card, a virtual gift card and a coupon. According to another embodiment of the invention, the method further comprises an act of permitting, an administrator, within an interface of the offer system, to define at least one offer rule.

According to one embodiment of the present invention, the method further comprises an act of creating the at least one offer rule, and associating the at least one offer rule with a plurality of gift cards that were previously issued to gift card recipients. According to another embodiment of the invention, the method further comprises an act of monitoring, in real-time, redemption of the offer. According to another embodiment of the invention, the method further comprises an act of triggering another offer rule and extending another offer responsive to the act of monitoring redemption of the offer. According to another embodiment of the invention, the method further comprises an act of modifying the offer responsive to the act of monitoring redemption of the offer. According to another embodiment of the invention, the method further comprises an act of issuing, by the offer management system, a new gift card responsive to the one or more actions by the user in relation to the gift card. According to another embodiment of the invention, the method further comprises an act of modifying a value of the gift card responsive to one or more actions by the user in relation to the gift card.

According to one embodiment of the present invention, the method further comprises an act of associating a coupon with the gift card responsive to the one or more actions by the user in relation to the gift card. According to another embodiment of the invention, the method further comprises an act of modifying a transaction parameter associated with a transaction performed using the gift card by the user.

According to one aspect of the present invention, a computer readable medium having computer-readable instructions stored thereon that define instructions that, as a result of being executed by a computer, instruct the computer to perform a method for administering a virtual gift card. The method comprises the acts of configuring, in an offer management system, one or more offer rules that define when an offer is presented to a user, associating the one or more offer rules with a gift card, and responsive to one or more actions by the user in relation to the gift card, the action triggering at least one of the one or more offer rules, extending an offer associated with the at least one of the one or more offer rules to the user. According to one embodiment of the present invention, the action comprises a purchaser purchasing the gift card. According to another embodiment of the invention, the offer is extended to the purchaser of the gift card. According to another embodiment of the invention, the offer is extended to a recipient of the gift card. According to another embodiment of the invention, the gift card is a virtual gift card, and wherein the offer management system interfaces with a virtual gift card management system. According to another embodiment of the invention, the action comprises a gift card recipient redeeming the gift card. According to another embodiment of the invention, the method further comprises acts of providing an interface to a terminal operated by a purchaser; the interface comprising fields for receiving a value and a recipient for the virtual gift card, receiving from the terminal, in response to input from the purchaser, the value and the recipient for the virtual gift card, generating a code for the virtual gift card, sending a message to the recipient of the virtual gift card, the message including the code for the virtual gift card, one or both of receiving, from a terminal operated by the recipient, a message including the code for the virtual gift card and an amount of a purchase, and receiving, from a terminal operated by the retailer, a message including the code for the virtual gift card and an amount of a purchase, and debiting, from an account associated with the recipient, the amount of the purchase.

According to one embodiment of the present invention, the extended offer relates to at least one of a physical gift card, a virtual gift card and a coupon. According to another embodiment of the invention, the computer readable medium further comprises an act of permitting, an administrator, within an interface of the offer system, to define at least one offer rule. According to another embodiment of the invention, the computer readable medium further comprises an act of creating the at least one offer rule, and associating the at least one offer rule with a plurality of gift cards that were previously issued to gift card recipients. According to another embodiment of the invention, the computer readable medium further comprises an act of monitoring, in real-time, redemption of the offer. According to another embodiment of the invention, the computer readable medium further comprises an act of triggering another offer rule and extending another offer responsive to the act of monitoring redemption of the offer. According to another embodiment of the invention, the computer readable medium further comprises an act of modifying the offer responsive to the act of monitoring redemption of the offer. According to another embodiment of the invention, the computer readable medium further comprises an act of issuing, by the offer management system, a new gift card responsive to the one or more actions by the user in relation to the gift card.

According to one embodiment of the present invention, the computer readable medium further comprises an act of modifying a value of the gift card responsive to one or more actions by the user in relation to the gift card. According to another embodiment of the invention, the computer readable medium further comprises an act of associating a coupon with the gift card responsive to the one or more actions by the user in relation to the gift card. According to another embodiment of the invention, the computer readable medium further comprises an act of modifying a transaction parameter associated with a transaction performed using the gift card by the user.

According to one aspect of the present invention, a system for administering a virtual gift card is provided. The system comprises a configuration component configured to, in an offer management system, create one or more offer rules that define when an offer is presented to a user, an associated component configured to associate the one or more offer rules with a gift card, and a component configured to respond to one or more actions by the user in relation to the gift card, the action triggering at least one of the one or more offer rules, extending an offer associated with the at least one of the one or more offer rules to the user. According to one embodiment of the present invention, the action comprises a purchaser purchasing the gift card. According to another embodiment of the invention, the offer is extended to the purchaser of the gift card. According to another embodiment of the invention, the offer is extended to a recipient of the gift card. According to another embodiment of the invention, the gift card is a virtual gift card, and wherein the offer management system interfaces with a virtual gift card management system. According to another embodiment of the invention, the action comprises a gift card recipient redeeming the gift card.

According to one embodiment of the present invention, the system further comprises providing an interface component configured to provide a user to a terminal operated by a purchaser; the interface comprising fields for receiving a value and a recipient for the virtual gift card, receiving from the terminal, in response to input from the purchaser, the value and the recipient for the virtual gift card, a component adapted to generate a code for the virtual gift card, a component adapted to send a message to the recipient of the virtual gift card, the message including the code for the virtual gift card, wherein the system comprises one or both of a component adapted to receive, from a terminal operated by the recipient, a message including the code for the virtual gift card and an amount of a purchase, and a component adapted to receive, from a terminal operated by the retailer, a message including the code for the virtual gift card and an amount of a purchase, and a component adapted to debit, from an account associated with the recipient, the amount of the purchase. According to another embodiment of the invention, the extended offer relates to at least one of a physical gift card, a virtual gift card and a coupon. According to another embodiment of the invention, the system further comprises a component that is adapted to permit an administrator, within an interface of the offer system, to define at least one offer rule. According to another embodiment of the invention, the system further comprises a component that is adapted to create the at least one offer rule, and associating the at least one offer rule with a plurality of gift cards that were previously issued to gift card recipients.

According to one embodiment of the present invention, the system further comprises a component that is adapted to monitor, in real-time, redemption of the offer. According to another embodiment of the invention, the system further comprises a component that is adapted to trigger another offer rule and extending another offer responsive to monitoring redemption of the offer. According to another embodiment of the invention, the system further comprises a component that is adapted to modify the offer responsive to monitoring redemption of the offer. According to another embodiment of the invention, the system further comprises a component that is adapted to issue, by the offer management system, a new gift card responsive to the one or more actions by the user in relation to the gift card. According to another embodiment of the invention, the system further comprises a component that is adapted to modify a value of the gift card responsive to one or more actions by the user in relation to the gift card. According to another embodiment of the invention, the system further comprises a component that is adapted to associate a coupon with the gift card responsive to the one or more actions by the user in relation to the gift card. According to yet another embodiment of the invention, the system further comprises a component that is adapted to modify a transaction parameter associated with a transaction performed using the gift card by the user.

Further features and advantages as well as the structure and operation of various embodiments are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an example offer management system in which various aspects in accord with the present invention may be implemented;

FIG. 2 illustrates an example offer management system consistent with principles of the present invention;

FIG. 3 illustrates an example process for managing offers consistent with principles of the present invention;

FIG. 4 illustrates another example offer management process consistent with principles of the present invention;

FIG. 5 illustrates an example computer system in which various aspects in accordance with the present invention may be implemented;

FIG. 6 illustrates an example timeline of offers that could be made to various entities consistent with principles of the present invention;

FIG. 7 shows an example interface that can be used to configure offers according to various embodiments consistent with principles of the present invention;

FIG. 8 shows another example interface that can be used to configure offers according to various embodiments consistent with principles of the present invention;

FIG. 9 shows yet another example interface that can be used to configure offers according to various embodiments consistent with principles of the present invention;

FIG. 10 shows another example interface that can be used to configure offers according to various embodiments consistent with principles of the present invention; and

FIG. 11 shows an example interface that may be used to manage offers.

### DETAILED DESCRIPTION

The aspects disclosed herein, which are in accord with the present invention, are not limited in their application to the details of construction and the arrangement of components set forth in the following description or illustrated in the drawings. These aspects are capable of assuming other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiments.

For example, according to various embodiments of the present invention, a computer system is configured to perform any of the functions described herein, including but not limited to, ranking the relevancy of content and providing blended results from a plurality of search functions. However, such a system may also perform other functions. Moreover, the systems described herein may be configured to include or exclude any of the functions discussed herein. Thus the invention is not limited to a specific function or set of functions. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items.

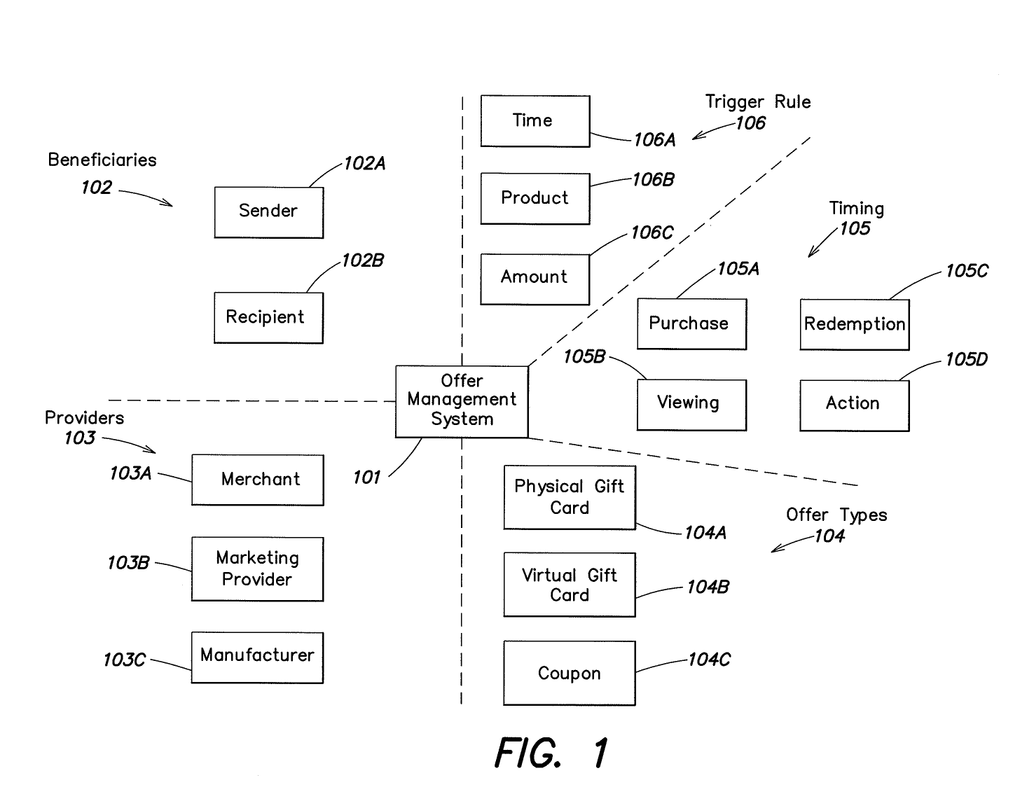

As discussed, one embodiment relates to an offer management system that is capable of creating and managing offers associated with gift cards. In one embodiment, the offer management system allows the association of an “offer” or “promotion” with a prepaid device (e.g. a virtual gift card). FIG. 1 shows various interactions of an offer management system according to various embodiments consistent with principles of the invention. As shown, there may be one or more types of beneficiaries 102 of the offers associated with gift cards. For instance, a sender 102A may be the beneficiary of a gift card offer. For example, the gift card sender/purchaser can be made an offer at the point when the gift card is purchased (e.g., if conditions are met, the purchaser can be provided with another gift card of a particular monetary value). Also, the recipient 102B of the gift card may also receive one or more offers responsive to actions taken with respect to the gift card (e.g., purchase, redemption, registration, etc.).

Entities that can provide offers (providers 103) may include any entity that can provide additional value to beneficiaries, including retailers such as, for example, a merchant 103A of products/services, a marketing provider 103B, manufacturer 103C, or other entity that desires to make an offer to a beneficiary 102. Such entities may interface with the offer management system to create and monitor the performance of offers provided to beneficiaries.

Also, as discussed, offers may take many different forms. For instance, there may be a number of different offer types 104 that can be associated with a gift card, such as, but not limited to, the issuance of a physical gift card 104A. In one example, a beneficiary receives a physical gift card when certain conditions are met. In one embodiment, another virtual gift card 104B can be issued to a beneficiary when certain criteria are met. For instance, when a sender purchases a virtual gift card to be sent to an email recipient, that recipient may be issued another virtual gift card. This additional gift card may be communicated to the email recipient along with the original gift card that was purchased by the sender. In another embodiment, a coupon 104C may be offered to the beneficiary. For instance, when the gift card recipient redeems a gift card and is purchasing a particular item, the gift card holder may be provided a coupon at the point of sale location, providing a discount off the purchase of that item.

In another embodiment, the value of an existing gift card may be modified by an offer. For instance, additional credit (e.g., dollar value) may be added to a gift card if particular criteria are met. In one example, if a gift card holder uses a particular gift card within a certain time period (e.g., the card was used to purchase at least $100 before April 1^{st}), value may be added back to the gift card. According to one embodiment, additional value may be added to an existing card without the need for issuance of a coupon or an additional gift card.

In yet another example, terms of a financial transaction may be modified responsive to the use of a gift card under particular circumstances. In one implementation, an offer may be made to a purchaser which provides a discount on a total purchase, or on a specific item. For instance, a gift card holder may receive, at a point of sale location, a discount if one or more offer rules are triggered. In one specific example, if a rule specifies that a gift card is used for a purchase within a particular point of sale location before a defined time, that cardholder receives 10% off the entire purchase. In yet another instance, if the card holder purchases a particular item, an offer rule may be defined that provides a discount of the purchase of that item when the gift card is used. In this way, the holder's purchasing behavior may be modified to suit the offeror's needs.

Further, certain conditions may be evaluated that determine when offers are made to beneficiaries and under what conditions. In one embodiment, an offer management system 101 may maintain one or more rules 106 that trigger when offers are made to beneficiaries 102. Trigger rules may specify parameters related to the offer, such as the time 106A of the offer (e.g., duration the offer lasts), the amount 106C of the offer (how much percentage, dollar amount, etc.), and/or the product 106B to which the offer applies. For instance, a certain manufacturer would like to increase sales of a particular product, and knows that there is approximately two million dollars outstanding held by beneficiaries of Sears branded gift cards. The manufacturer may design an offer that targets Sears gift card holders to increase the sale of that particular product. Further, the offer may last until a certain number of the particular item is sold, the amount of dollars exceeds a certain amount, or lasts beyond a predetermined time.

Rules may also be defined that determine the value of an offer, such as a minimum or maximum award value, a percentage value (e.g., of a purchase price of a gift card purchase), an absolute value setting for an offer to be made, formula-based offer, or other way of determining an offer value.

Other examples using different parameters are possible. However, it is appreciated that it would be beneficial to influence the behavior of gift card holders by extending offers to the beneficiaries of the gift cards.

Further, the timing (e.g., timing element 105) of when offers are made may be controlled by the offer management system. For instance, rules may be created that are triggered by certain events, such as a purchase 105A of a gift card, a redemption 105C of a gift card, viewing if the status of the gift card 105B (e.g., an online status of the amount remaining on the gift card), or any other action 105D taken with respect to the gift card. According to one embodiment, the timing of offers can occur at any point during the gift card's existence, from creation through exhaustion (and possibly later).

In yet another embodiment, offers may be made in several ways, including creating one or more secondary virtual gift cards (VGCs) or by supplementing a primary virtual gift card (VGC) that initiated the offer. Another type of offer is what is termed herein as a gift offer which is triggered based on a VGC but results in an award that does not cause a creation or supplement to a VGC.

Offers could be applied to VGCs and triggered in many ways, including applying an offer rule as a default to a particular branded VGC configuration, making that offer available to the holders of the branded VGCs. That is, the offer may be tied to particular VGCs. Other offers may be created outside a particular VGC, (e.g., on a website as a general or custom-specific offer), and then after-associated with a particular VGC (e.g., when the identified customer purchases a VGC).

In yet another example implementation, offers with VGCs may be accomplished in many ways, including associating an offer with a primary VGC which an end-user purchases, creating a secondary VGC as a result of an offer triggered in relation to a primary VGC (e.g., an action involving a primary VGC), and/or creation of multiple VGCs associated with a single transaction, such as permitting a user to purchase one or more VGCs, each of which may result in an offer to be triggered and awarded.

Offers associated with a particular VGC may be transaction-based and independent of other VGCs in that the offer is independent of other actions of other VGCs used in a transaction. In one implementation, a VGC may be evaluated (and an offer triggered) as through the VGC had been purchased in a separate transaction. What is referred to herein as a cumulative offer that may evaluate more than one VGC used within a particular purchase transaction, and make an appropriate offer. For instance, an offer management system may include an accumulator that increments itself with multiple parameters used in a transaction (e.g., a total of $100 of gift card funds used among three (3) different VGSs), and uses those parameters to trigger an offer (e.g., create a secondary VGC for the entire purchase). Thus, according to one embodiment, offers may be based on actions accumulated over multiple gift cards (e.g., VGCs).

Further, as discussed, an offer may be associated with a primary VGC. For instance, an extra reward value may be calculated based on a purchase price of a primary VGC, and then added to the original value of the VGC. Thus, the value of the primary VGC is increased based on the offer. For instance, a purchaser may spend $80 for an individual VGC, but the full value that the recipient receives is $100.

In another implementation, an offer may result in the issuance of one or more secondary VGCs. For instance, when a primary VGC is purchased (e.g., on website), parameters relating to the primary VGC may be evaluated to determine if an offer is triggered and a secondary VGC is created.

In yet another example, a cumulative offer may be created such that one or more VGCs are evaluated (e.g., by the use of one or more VGCs in a transaction), and an offer is made after all of the applicable VGCs are evaluated. For instance, each primary VGC's purchase amount may be accumulated and a final total may be used to determine any applicable worth to be allocated to a newly-issued secondary VGC. In a further implementation, another cumulative offer type may be created that evaluates VGCs individually, and any individual worths can be accumulated and assigned to a newly-issued VGC. Other offer types may be structured that use any of the calculation types as discussed above, but result in the award of a gift and/or coupon.

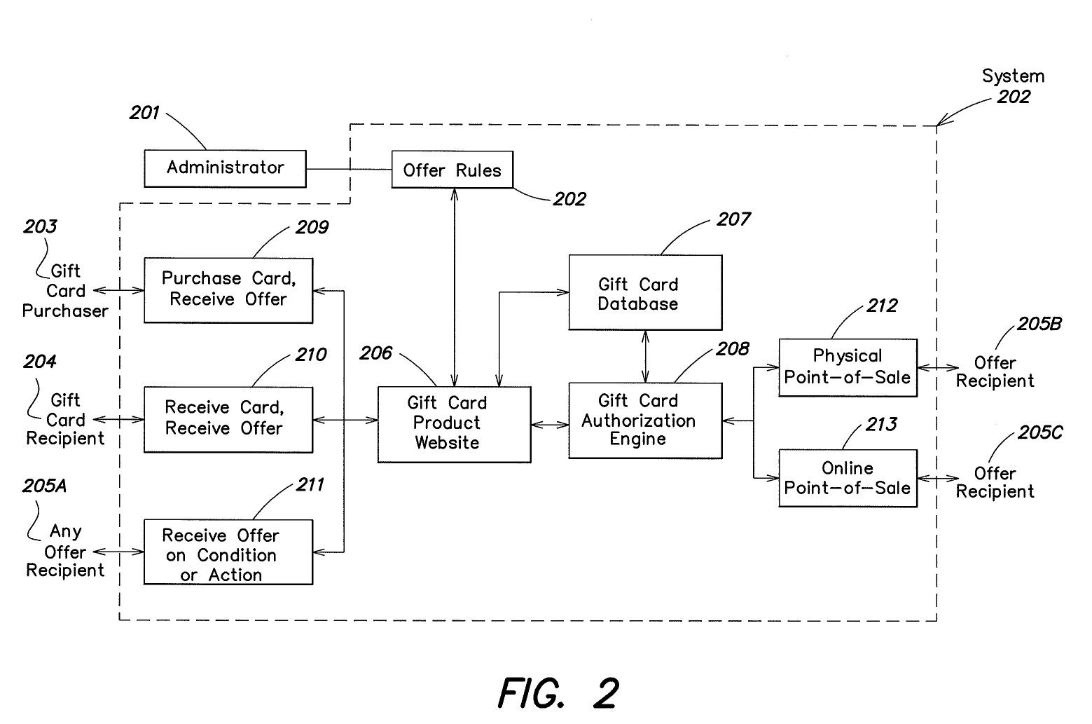

FIG. 2 shows one embodiment of an offer management system 200 consistent with principles of the invention. System 200 may permit, for example, the purchase, tracking, redemption of gift cards (e.g., a VGC). The system may be capable of allowing an administrator 201 (e.g., an agent of a retailer that creates and manages offers on behalf of the retailer) to create one or more rules that define under what conditions an offer is created in association with a gift card. Further, system 200 may permit a gift card purchaser 203 to purchase a gift card (e.g., a physical or virtual gift card) that can be provided to a gift card recipient 204.

According to one embodiment, either the gift card purchaser 203 or recipient 204 may receive an offer from the offer management system 200. Further, it is appreciated that any other recipient 205A may receive an offer from the offer management system 200. For instance, recipient 205A may receive an offer in response to any condition or action may the recipient or any other user.

In one implementation, the gift cards may be virtual gift cards that are represented electronically by system 200 and are communicated to recipients. To this end, a gift card product website 206 may be provided that permits users to purchase and send gift cards to recipients, to manage their gift card purchases, and perform other actions with respect to gift cards. For instance, the gift card product website may include a component 209 that permits a gift card purchaser to purchase a gift card for himself/herself or another person. Further, the website may include one or more components 210 that permit a recipient to receive a gift card from a purchaser. Further, according to various embodiments, components 209 and/or 210 may include the capability to extend an offer to a gift card purchaser 203 or gift card recipient 204. Generally, website 206 may include a component 211 that makes an offer to a recipient 205A in response to particular condition(s) being met or an action by a user.

System 200 may maintain one or more offer rules 202 that determine when, what type, and to whom particular offers may be made. These rules may be stored by system 200, and when triggered, may cause the offer to be made. These rules may be stored and distributed among components of a distributed computer system and used by various components to trigger offers. Also, system 200 may maintain a gift card database 207 that tracks information relating to the gift card, such as a unique gift card identifier, identification of the purchaser/recipient, amount of the gift card, or any other information relating to the gift card transaction. In one embodiment, users may be permitted to register their gift cards to an online identity (e.g., username/password), and that information may be stored in the gift card database 207.

System 200 may also include a gift card authorization engine 208 that determines if the gift card holds sufficient value to perform a transaction, and to transfer the funds to the vendor where the transaction is performed. According to one embodiment, the authorization engine may be adapted to communicate information to an offer engine to determine available offers to be communicated to a user of a gift card at a point-of-sale location. For instance, an offer recipient 205B may wish to perform a purchase using a physical gift card at a physical point-of-sale location 212. Responsive to the offer recipient 205B attempting to use the gift card, the recipient may be presented an offer for use in the current transaction, or a later transaction (e.g., to encourage patron return).

As discussed, a recipient could receive a coupon (e.g., one that applies to a product the recipient is currently purchasing with the gift card), another gift card (e.g., to be used in a future transaction), an added value back to the gift card currently being used (e.g., add $10 back to the current gift card), or any other offer as appropriate. Also, a recipient 205C of a virtual (or physical) gift card may use such a card to make purchases in an online environment at an online point-of-sale 213. There, the recipient 205C may use the gift card to perform a purchase, and again one or more offers may be communicated to the recipient in a similar manner as discussed above with respect to the physical point-of-sale environment. In addition, the online environment may also include various methods by which a recipient 205C may receive an offer, such as an email, an electronic coupon or virtual gift card, etc., and that offer may be communicated by any one or combination of electronic methods (e.g., email, text, XML, etc.).

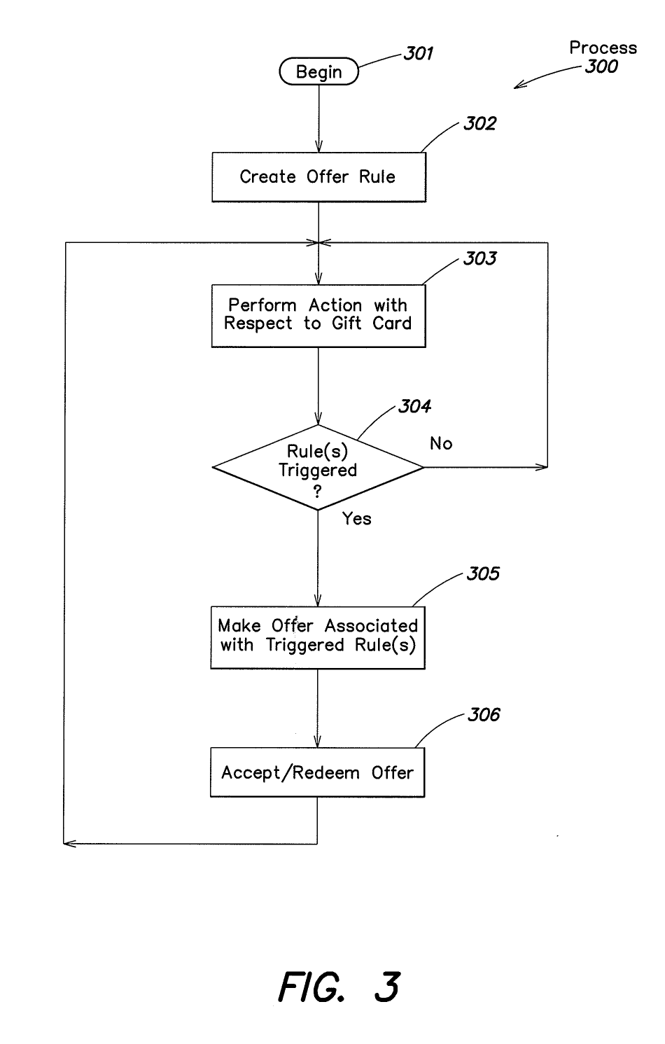

FIG. 3 shows a process 300 for managing offers in an offer management system according to one embodiment. Process 300 may be performed, for example, by an offer management system 200 as discussed above with reference to FIG. 2. At block 301, process 300 begins. At block 302, a rule is created that defines under what condition(s) an offer is made with respect to a gift card action. For instance, as discussed above, an administrator for a retailer may be provided tools to design offer programs and more particularly, interfaces that define the rules which trigger offers made to users.

At block 303, a user performs an action with respect to a gift card, such as an initial purchase of a gift card, online viewing of the gift card, redemption of the gift card, or other action. Responsive to certain actions being performed, there may be one or more offer rules that are triggered. At block 304, it is determined whether one or more of the stored offer rules are triggered by the actions taken by the user. If not, the system (e.g., system 200) continues to monitor actions performed with respect to a created gift card.

However, if an offer rule is triggered, the offer management system makes an offer (e.g., at block 305) to the user (or any other user) associated with the triggered rule(s). These offers may be presented to the user for use in the current or future transaction, where they can be accepted/redeemed by the user at block 306. Process 300 continues to monitor transactions, and new rules can be created, modified, deleted, or may expire on their own accord.

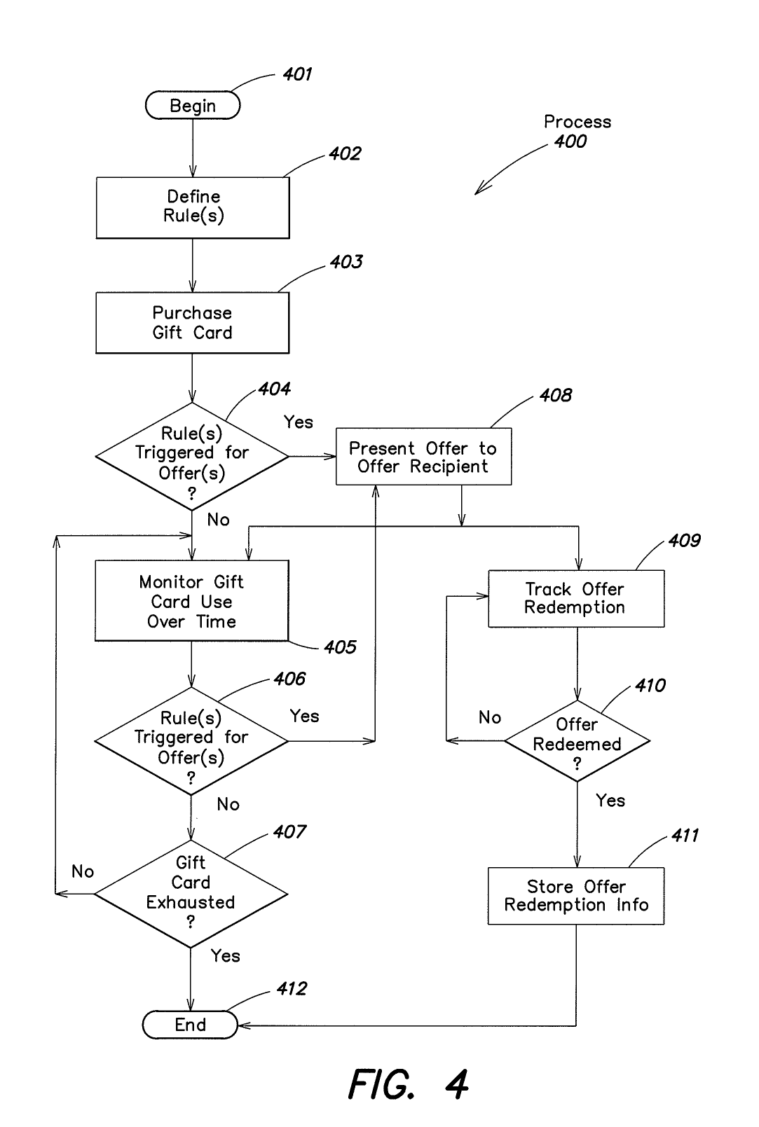

FIG. 4 shows another process 400 for managing offers in an offer management system according to one embodiment. Process 400 may be performed, for example, by an offer management system 200 as discussed above with reference to FIG. 2. At block 401, process 400 begins. At block 402, an administrator or other user defines an offer rule in a similar manner as discussed above with respect to FIG. 3. At block 403, a user (e.g., gift card purchaser 203) purchases a gift card. Responsive to the user purchasing a gift card, such as a user purchasing a virtual gift card at a website, it is determined whether any offer rules are triggered by the purchase. At block 404, if it determined that any rules are triggered, one or more offers are presented to the offer recipient at block 408. The offer recipient may be the purchaser, the gift card recipient, and/or any other user.

If no rules are triggered at the point of sale, then the offer management system may proceed to monitor gift card use over time (block 405). If, during the existence of the gift card (e.g., at block 406), an offer rule is triggered, then that offer is presented to the offer recipient (e.g., at block 408). If no rules are triggered, and it is determined that the gift card is exhausted (e.g., at block 407), process 400 ends. If not, the offer management system continues to monitor gift card usage.

Further, if an offer is made to an offer recipient, then the offer management system may be capable of tracking the offer and recording information relating to the redemption history. For instance, at block 409, offer management system tracks the redemption of the outstanding offer. If it is determined that the offer is redeemed at block 410, then redemption information is stored at block 411, and the tracking of that particular offer ends. The offer management system, according to one embodiment, may be capable of storing, analyzing, and presenting historical offer redemption information for multiple offers and users to an administrator or other user for analysis. Such information may be useful, for example, in the design and implementation of future offer campaigns, rules, and settings.

### Computer System

Various aspects and functions described herein in accord with the present invention may be implemented as hardware or software on one or more computer systems. There are many examples of computer systems currently in use that may be suitable for implementing various aspects of the present invention. Some examples include, among others, network appliances, personal computers, workstations, mainframes, networked clients, servers, media servers, application servers, database servers and web servers. Other examples of computer systems may include mobile computing devices, such as cellular phones and personal digital assistants, network equipment, devices involved in commerce such as point of sale equipment and systems, such as handheld scanners, magnetic stripe readers, bar code scanners and their associated computer systems, among others. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system elements and components using a variety of hardware and software configurations, and the invention is not limited to any particular distributed architecture, network, or communication protocol.

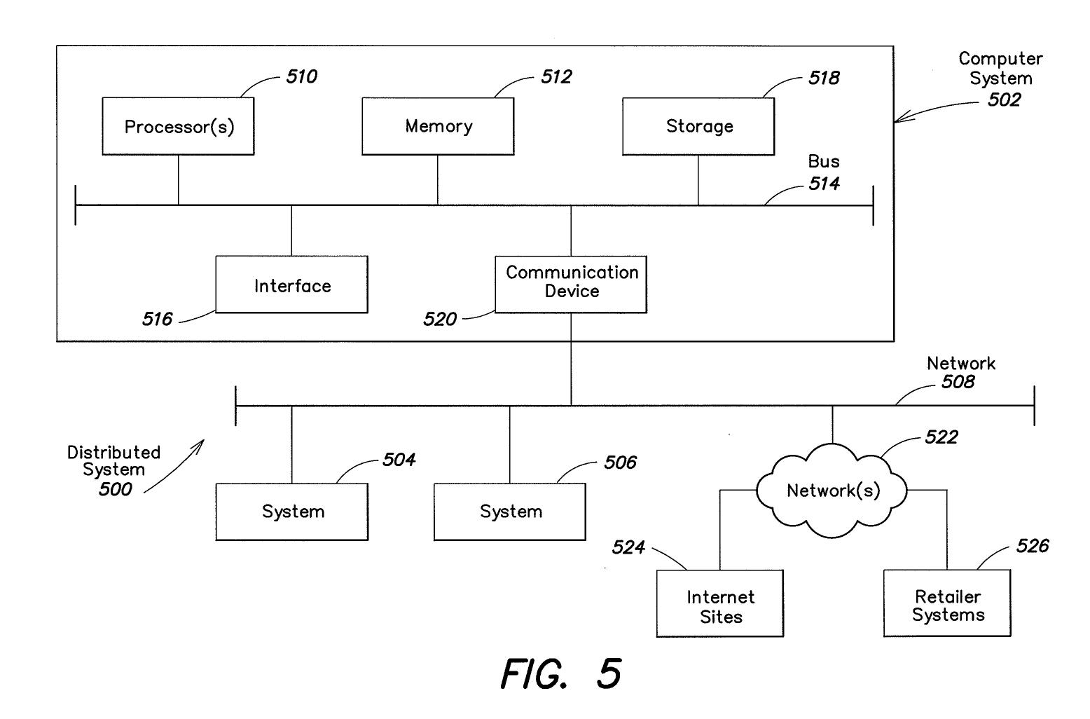

FIG. 5 shows a block diagram of a distributed computer system 500, in which various aspects and functions in accord with the present invention may be practiced. The distributed computer system 500 may include one more computer systems. For example, as illustrated, the distributed computer system 500 includes three computer systems 502, 504 and 506, but distributed computer system 500 could include any number of systems. As shown, the computer systems 502, 504 and 506 are interconnected by, and may exchange data through, a communication network 508. Network 508 may include any communication network through which computer systems may exchange data. To exchange data via network 508, the computer systems 502, 504 and 506 and the network 508 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM and/or Web Services. To ensure data transfer is secure, the computer systems 502, 504 and 506 may transmit data via the network 508 using a variety of security measures including TSL, SSL or VPN, among other security techniques. While the distributed computer system 500 illustrates three networked computer systems, the distributed computer system 500 may include any number of computer systems, networked using any medium and communication protocol or combination thereof.

Various aspects and functions in accord with the present invention may be implemented as specialized hardware or software executing in one or more computer systems including a computer system 502 shown in FIG. 5. As depicted, the computer system 502 includes a processor 510, a memory 512, a bus 514 or other internal communication system, an interface 516, a storage system 518 and a communication device 520. Processor 510, which may include one or more microprocessors or other types of controllers, can perform a series of instructions that result in manipulated data. Processor 510 may be a commercially available processor such as an Intel Pentium, Motorola PowerPC, SGI MIPS, Sun UltraSPARC, or Hewlett-Packard PA-RISC processor, but may be any type of processor or controller as many other processors and controllers are available. As shown, processor 510 may be connected to other system elements, including a memory 512, by bus 514.

Memory 512 may be used for storing programs and data during operation of the computer system 502. Thus, memory 512 may be a relatively high performance, volatile, random access memory such as a dynamic random access memory (DRAM) or static memory (SRAM). However, memory 512 may include any device for storing data, such as a disk drive or other non-volatile storage device. Various embodiments in accord with the present invention can organize memory 512 into particularized and, in some cases, unique structures to perform the aspects and functions disclosed herein.

Components of computer system 502 may be coupled by an interconnection element such as bus 514. Bus 514 may include one or more physical busses (for example, busses between components that are integrated within a same machine), but may include any communication coupling between system elements including specialized or standard computing bus technologies such as IDE, SCSI, PCI and InfiniBand. Thus, bus 514 may enable communications (for example, data and instructions) to be exchanged between system components of the computer system 502.

The computer system 502 also includes one or more interface devices 516 such as input devices, output devices and combination input/output devices. Interface devices 516 may receive input or provide output. More particularly, output devices may render information for external presentation. Input devices may accept information from external sources. Examples of interface devices include, among others, keyboards, bar code scanners, mouse devices, trackballs, magnetic strip readers, microphones, touch screens, printing devices, display screens, speakers, network interface cards, etc. The interface devices 516 allow the computer system 502 to exchange information and communicate with external entities, such as users and other systems.

Storage system 518 may include a computer readable and writeable nonvolatile storage medium in which instructions are stored that define a program to be executed by the processor. Storage system 518 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. The medium may, for example, be optical disk, magnetic disk or flash memory, among others. In operation, processor 510 or some other controller may cause data to be read from the nonvolatile recording medium into another memory, such as the memory 512, that allows for faster access to the information by the processor than does the storage medium included in the storage system 518. The memory may be located in storage system 518 or in memory 512. Processor 510 may manipulate the data within memory 512, and then copy the data to the medium associated with the storage system 518 after processing is completed. A variety of components may manage data movement between the medium and integrated circuit memory element and the invention is not limited thereto. Further, the invention is not limited to a particular memory system or storage system.

Although computer system 502 is shown by way of example as one type of computer system upon which various aspects and functions in accord with the present invention may be practiced, aspects of the invention are not limited to being implemented on the computer system as shown in FIG. 5. Various aspects and functions in accord with the present invention may be practiced on one or more computers having a different architectures or components than that shown in FIG. 5. For instance, computer system 502 may include specially-programmed, special-purpose hardware, such as for example, an application-specific integrated circuit (ASIC) tailored to perform a particular operation disclosed herein. While another embodiment may perform the same function using several general-purpose computing devices running MAC OS System X with Motorola PowerPC processors and several specialized computing devices running proprietary hardware and operating systems.

Computer system 502 may include an operating system that manages at least a portion of the hardware elements included in computer system 502. A processor or controller, such as processor 510, may execute an operating system which may be, among others, a Windows-based operating system (for example, Windows NT, Windows 2000 (Windows ME), Windows XP, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various aspects and functions in accord with the present invention may be implemented in a non-programmed environment (for example, documents created in HTML, XML or other format that, when viewed in a window of a browser program, render aspects of a graphical-user interface or perform other functions). Further, various embodiments in accord with the present invention may be implemented as programmed or non-programmed elements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing commercial product, such as, for example, Database Management Systems such as SQL Server available from Microsoft of Seattle Wash., Oracle Database from Oracle of Redwood Shores, Calif., and MySQL from Sun Microsystems of Santa Clara, Calif. or integration software such as WebSphere middleware from IBM of Armonk, N.Y.

Other elements of the offer management system may include other types of well-known systems such as credit card processing systems such as those available commercially from Hypercom, Verifone, Nurit, and other providers. Various systems of the offer management system may integrate with other types of payment systems, such as debit card processing systems, check card readers, PC-based payment terminal systems, among others. For instance, various embodiments may be capable of working with one or more systems or components coupled through one or more communication networks (e.g., networks 522). For example, the offer management system may integrate with, or be incorporated into, one or more Internet-based systems (e.g., Internet sites 524), retailer systems (e.g., element 526) or other computer-based systems that interact with gift card programs. According to one embodiment, these types of systems may be adapted to manage offers associated with gift cards. Some examples and embodiments of the systems and methods that may be implemented according to the systems and methods described herein may be implemented using systems similar to those described in U.S. patent application Ser. No. 11/946,748, entitled PRE-PAID PAYMENT INSTRUMENT PROCESSING incorporated herein by reference.

### Example Scenarios

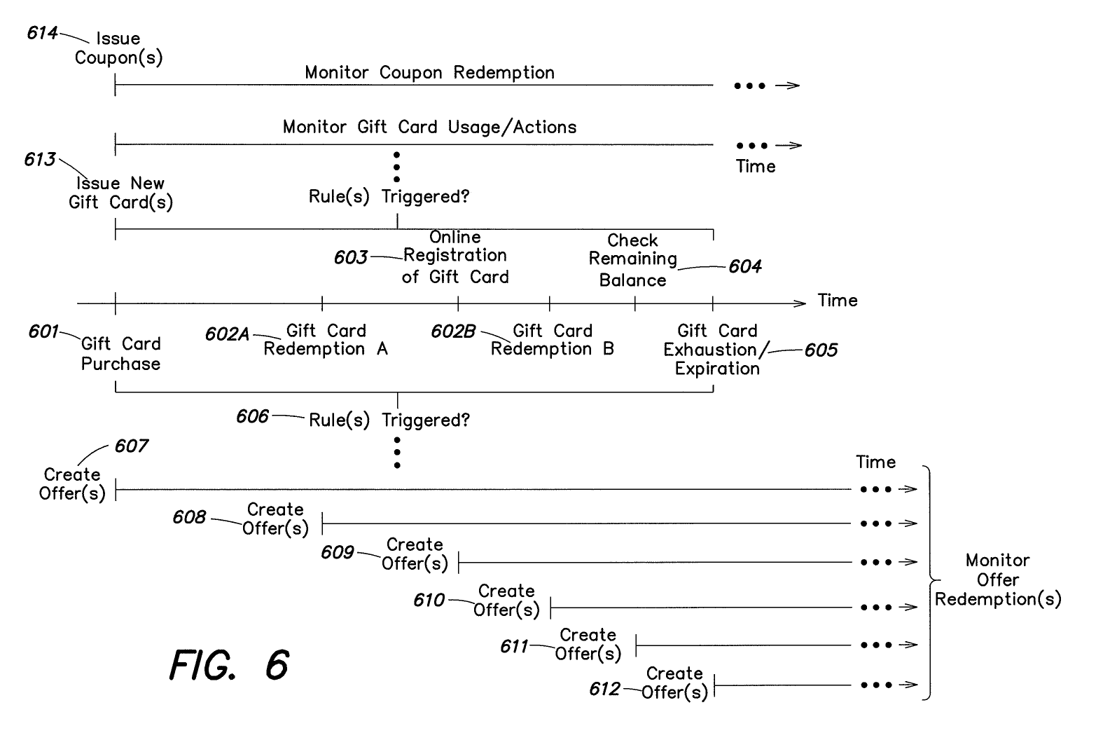

As can be appreciated, there are a number of different offer scenarios that can be achieved by various aspects of the present invention. For instance, as shown in more detail in FIG. 6, there may be one or more actions that cause an offer to be made by an offer management system. For instance, a purchaser may purchase a gift card at point 601 in time as shown in FIG. 6. For one example gift card, there may be one or more redemptions (e.g., redemption A (item 602A)), redemption B (item 602B)), etc.) that can cause an offer to be made. Also, there may be other actions such as an online registration of a gift card (e.g., at point 603), a check of a remaining balance (e.g., at point 604), a viewing of a received gift card, an expiration/exhaustion of a gift card (e.g., at point 605), or other action that may trigger an offer rule.

If a rule is triggered at any point during the life of the gift card (e.g., at any point during period 606), one or more offers may be created (e.g., offers 607-612). Each of these offers may then be monitored by the offer management system. These offers could outlive the life of the gift card (e.g., the offer may extend beyond the expiration of the originating gift card), and the monitoring system could provide additional offers based on the extended offers.

Further, as discussed above, the offer management system may be capable of issuing a new gift card (e.g., at point 613) responsive to some action. That gift card may itself be the basis of one or more associated offers that can be triggered from that newly-created gift card. In another embodiment, the offer may include issuing one or more coupons (e.g., at point 614), and the offer management system may be adapted to monitor the use of those issued coupons. Although several different scenarios are shown, it should be appreciated that any number and combination of offers may be created and tracked by an offer management system.

According to one embodiment of the present invention, complex offers may be created using one or more rules. These rules may trigger alone or may work in combination with each other. One example type of offer that may be created using such rules may include the ability to provide offers that degrade as consumers who hold gift cards make purchases or otherwise take actions in relation to their gift cards. Such functionality may be accomplished, for example, by permitting real-time monitoring of redemptions, and the modification of existing offers or creation of new offers responsive to monitoring redemptions.

In one specific example, an offer is made to all holders of Home Depot gift cards (e.g., virtual gift cards), the first 1000 customers to use their gift card towards purchases of $50 or greater will receive 25% uplift on the value of their gift card. The next 1000 customers to use their gift cards will receive 15% uplift and all other customers who use their gift cards before Apr. 30, 2009 will receive 5% uplift. Notably, a degrading incentive (25%, 15%, 5%) may be provided that is tied to subsets of gift card holders (first 1000, second 1000, all) who take action (make a purchase of >$50) within a window of time (before Apr. 30, 2009). This degrading incentive allows retailers to use competition (amongst gift card holders) to incite buying activity. Such an offer may be represented by a rule that may be triggered when consumers use the gift card in question. Because a coordinated system may be used to monitor and trigger offers in real time, the actual number of customers that exhibit certain behavior may be tracked and used as a basis for extending an additional offer (e.g., when the behavior is exhibited or at a future time) to a consumer. Other complex offers may be tailored to the specific situation and consumer behavior that is desired by the retailer.

### Example Gift Card Interfaces

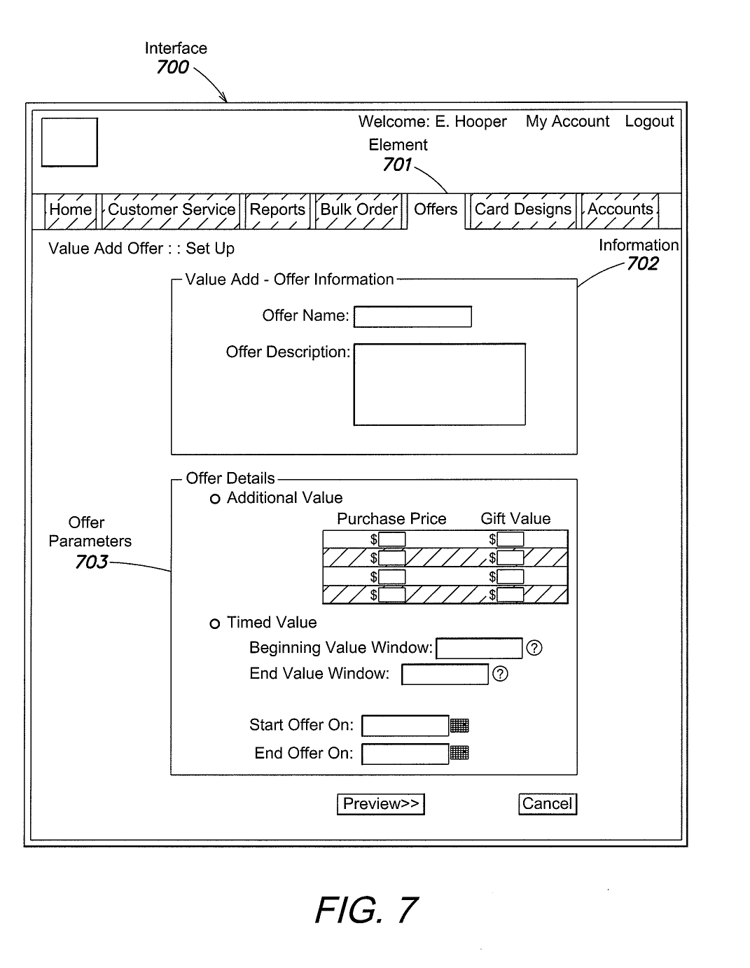

As discussed, there may be one or more computer-based interfaces that permit a user to configure and administer offers. FIG. 7 shows one example interface 700 that may be used to configure offers consistent with principles of the present invention. As shown, an interface 700 may include one or more elements (e.g., element 701) that, when selected, permit a user to configure one or more offers within an offer management system. For instance, according to one embodiment, the interfaces may be web-enabled interfaces that permit an Internet user to configure and manage offers. Interface 700 may also include controls that permit a user to save and activate defined offers (not shown).

Element 701 may include an offer configuration window having one or more information items that a user can configure. For instance, information 702 may be entered which may include identifying information for a configured offer, such as, for example, a name of the offer and a description of the offer. The particular offer type, according to one embodiment, may be one where in response to an action such as a purchase, additional value is added back to the gift card. For instance, the particulars of the purchase price that triggers value added back to the card may be specified as one or more offer parameters 703. For example, a purchase of $100 (or more) using the gift card may trigger a value of $10 being added back to the value of the card.

A user may be permitted to specify other parameters relating to the offer, such as time. For instance, a timed value information may be created that specifies when an offer starts and stops (e.g., a calendar day), and a window for the beginning and ending value. According to one embodiment, an offer value may be adjusted within the offer period according to the time the offer is triggered within the offer window.

According to various embodiments, one or more additional parameters may be used to control offer behavior and/or value. Such parameters may be useful, for example, permitting gradations across a range of purchase amounts for a particular gift card. For instance, a start and end range may be defined such that an offer falling within this range may be available to the gift card purchaser or recipient. If the card does fall within this range, an offer may be made to the gift card purchaser or recipient, and that offer's value may be further dependent upon one or more additional parameters.

An offer value parameter (which may be configurable by a gift card administrator) may indicate whether the value of the offer is a monetary amount to be added to the primary card or newly-issued secondary card, a percentage value applied to the current purchase, or some other way of calculating value. If the value is a percentage, that percentage value may be applied as an additional parameter that can be set by the gift card administrator.

Further, there may be minimum and maximum value parameters that control how small or large the award associated with the offer could be worth. For instance, if a percentage is used and is applied to the purchase price to determine a reward worth, minimum and maximum parameters may be set to control boundary cases (e.g., cases where the percentage worth is less than the minimum value or greater than the maximum value). For instance, if a value percentage of 10% is applied to a $16 purchase, the reward worth results in a value of $1.60. However, if the minimum value parameter is enabled and set to $2.00, in the previous example, the reward value will be set to $2.00.

Other parameters that affect offer value may be used. For instance, a per transaction limit parameter may be used to limit a number of times per transaction that a corresponding reward value can be applied for a matching purchase price range. For instance, a limit of three rewards could be used for a particular transaction.

Also, an available count parameter could be provided that, if set, would apply all available rewards across all transactions. For instance, this feature could allow for offers that specify that only the first 100 purchasers are eligible to receive the award.

In another example, a formula or function-based determination may be used that can determine a resultant reward. In one implementation, the purchase price of the gift card may be provided as a variable to the formula or function. Other parameters, such as a promotional value that should scale in relation to the gift card value may also be provided. For example, in one implementation, a formula-based approach may be defined such that if a percent parameter is set and the a resulting value calculated is a non-whole number, a formula may be applied to modify the value amount, such as applying a minimum, maximum or rounding function that truncates the value amount. Although many examples are provided above on how offers can be triggered and applied, it should be appreciated that other applications of parameters may be used to modify the behavior of the offer and its associated value. Any of these parameters may be provided within an interface presented to an offer administrator, and the interface may permit the administrator to configure the behavior of a particular offer.

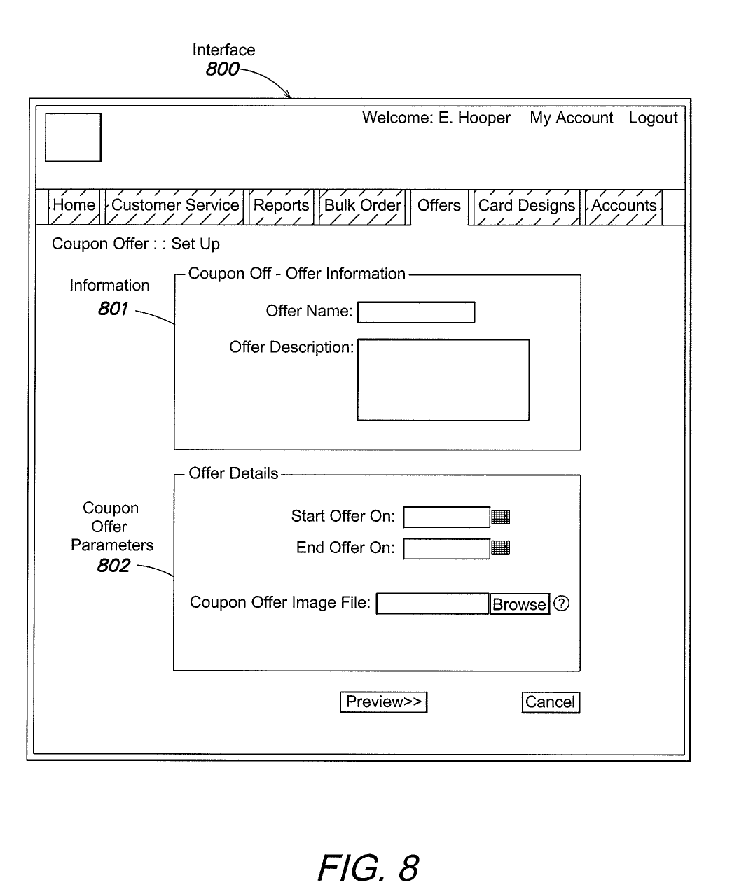

FIG. 8 shows another example interface that permits a user to define offers in a manner consistent with principles of the present invention. To this end, an interface 800 is provided that permits a coupon offer to be created, wherein the coupon is provided responsive to an action performed by the gift card recipient (e.g., purchasing the item to which the coupon applies). In one embodiment, the interface may have similar offer identifying information 801 as that discussed above with reference to FIG. 7. Further, interface 800 may also include one or more coupon offer parameters 802 that indicate the conditions under which a coupon is offered to the gift card recipient. In one embodiment, parameters 802 include timing information that defines when the coupon is offered to the gift card holder. Parameters 802 may also include a reference to an image file associated with the coupon. This information may be displayed to the gift card holder, for instance, when the coupon offer is made (e.g., at a kiosk, point of sale, online purchasing window or other location). In a similar manner to other types of offers, coupon offers may be created and saved by an offer management system.

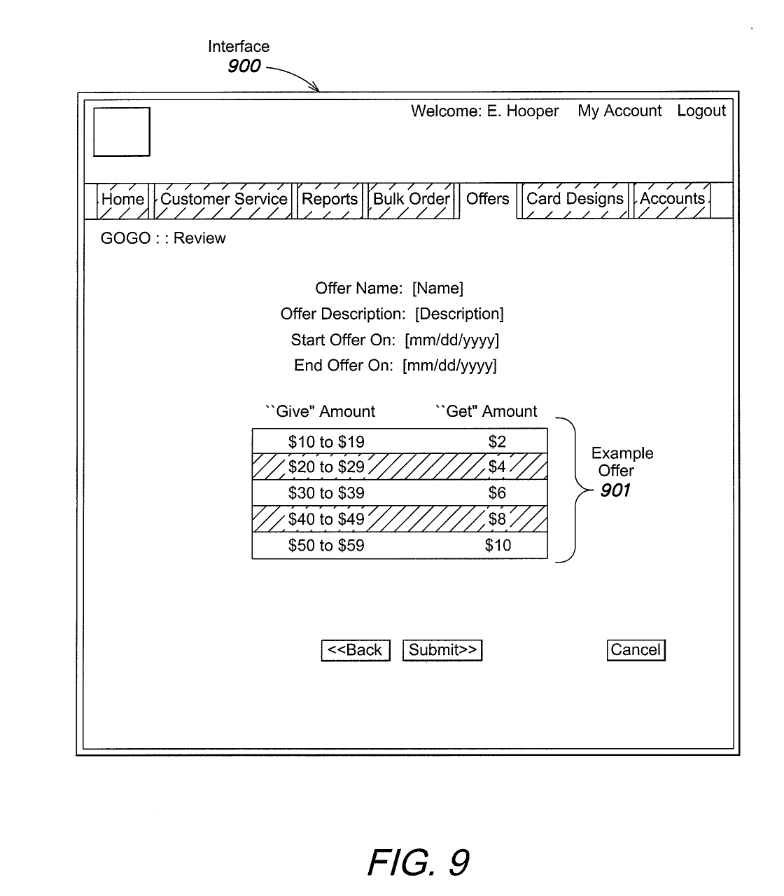

FIG. 9 shows another interface 900 that permits a user to create offers in a manner consistent with principles of the present invention. In particular, interface 900 permits what is termed herein as a “GOGO” offer, which means “Give One, Get One”. That is, a gift card purchaser that purchases a gift card for particular value (the “give” amount) is also given another gift card of a particular value (the “get” amount). The gift cards may be purchased by a user and given to another person. Also, the user may be permitted to purchase the gift card for their own use, and receive another gift card having value. Similar to other types of offers discussed above, interface 900 may include one or more portions of information that identify a particular GOGO offer. Other parameters such as timing may also be provided.

According to another embodiment, a GOGO offer may be defined that has a plurality of rules that interact to determine what offer is made to the gift card purchaser. For instance, as part of an example offer 901, multiple Give/Get amounts may be defined that determine how much value is attributed to the gift card that is awarded to the gift card purchaser. According to one embodiment, the “give” amount may be characterized by a range of purchase values. If a gift card purchaser purchases a designated gift card type that has the value range specified by the GOGO offer defined, then that gift card purchaser receives another prepaid gift card of the value specified by the GOGO offer.

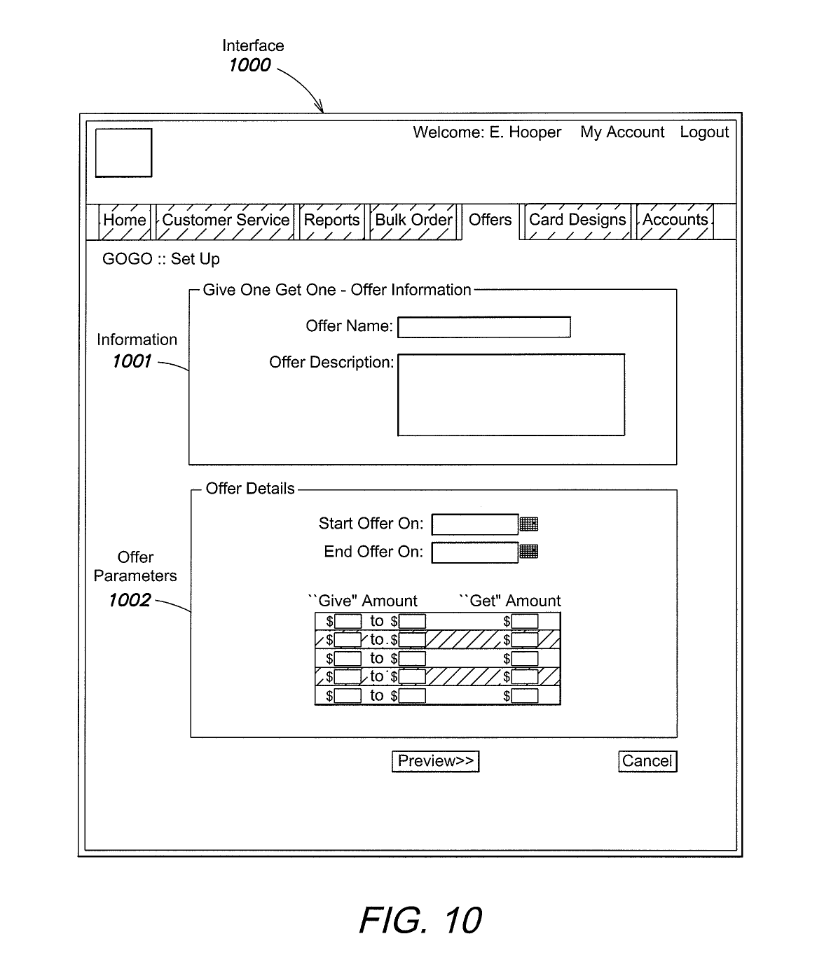

FIG. 10 shows yet another interface that permits a user to define offers in a manner consistent with principles of the present invention. To this end, an interface 1000 is provided that permits a “GOGO” offer to be defined as discussed above with reference to FIG. 9. The GOGO offer may also include information 1001 that have similar offer identifying information as that discussed above with reference to FIG. 7. Further, interface 1000 may also include one or more offer parameters 1002 that indicate the conditions under which a coupon is offered to the gift card recipient. In one embodiment, parameters 1002 include timing information that defines when the coupon is offered to the gift card holder. Further, in association with the GOGO offer, a user may be permitted to define one or multiple Give/Get combinations that define the triggering behavior of the GOGO offer. Similar to other offer types, GOGO offers defined by the user may be saved by the offer management system and implemented in systems that permit the purchase of gift cards, either physical or virtual.

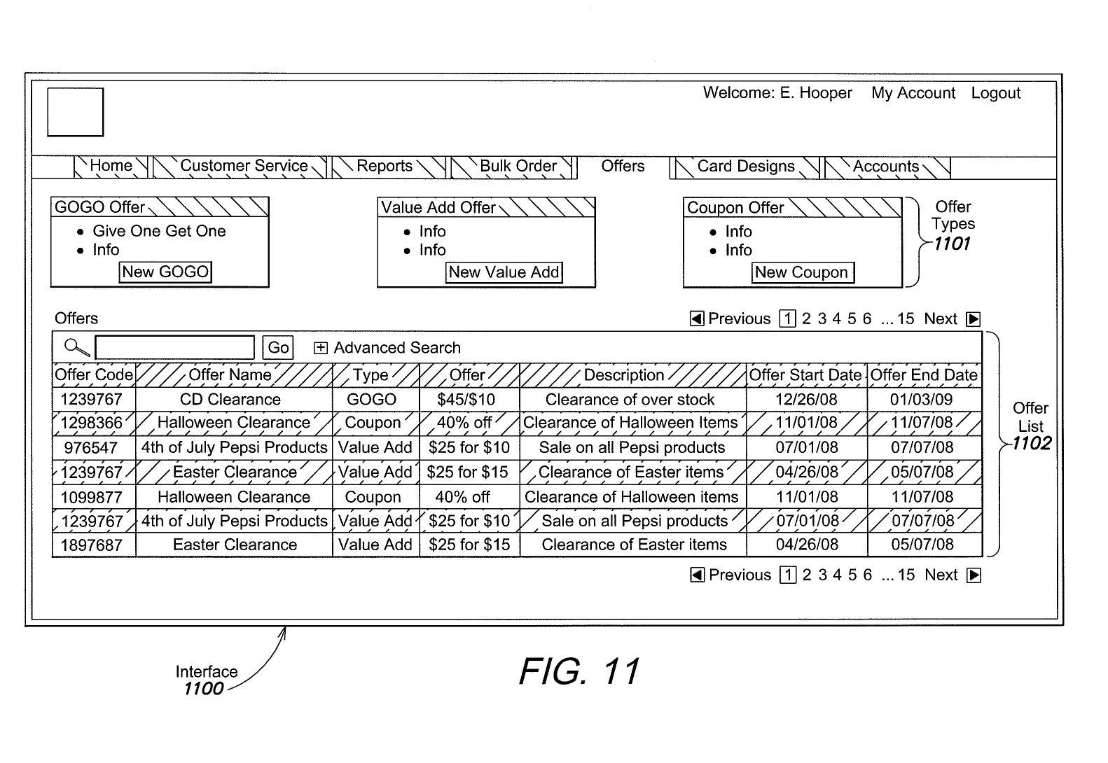

FIG. 11 shows yet another interface 1100 that can be used to administer offers consistent with principles of the present invention. In particular, an offer management system may include an interface 1100 that permits users to create, manage, delete, and perform other functions for a distributed offer management system. Interface 1100 may include controls that permit a user to create one or more offer types as discussed above with reference to FIGS. 7-10, or any other offer type that may be created and implemented within an offer management system. Interface 1100 may include a list 1102 of offers (or other similar presentation function) that permits a user to clearly see the offers that are being managed by the offer management system. To this end, list 1102 may include identifying information for each of the stored offers, the offer type, offer amount, timing information, and any other information associated with the particular offer. The management system may permit the user to select an offer, modify the selected offer, delete the offer, disable the offer or perform any other function in relation to a created offer. Although FIGS. 7-11 are shown by way of example, it should be appreciated that such interfaces may be extended to support other offers having more or less parameters or behavior.

### Example Virtual Gift Card System Architecture

As discussed, various aspects of the present invention may be implemented within a virtual gift card system. In certain embodiments, a system for providing or administering virtual gift cards that includes an offer management system is a hosted service offering which allows a retailer (or other merchant or business) to offer its customers the opportunity to purchase virtual gift cards via its own website or via a third party website. A system for providing or administering virtual gift cards can be constructed according to a processor model or according to a distributor model. In the processor model, the provider of the virtual gift card platform may generate codes that are used to identify virtual gift cards. Additionally, in the processor model, the provider of the virtual gift card platform may maintain a database of virtual gift cards. Where the provider maintains such a database, purchases made with the virtual gift card may be directed to the database so that information, such as the remaining balance on the virtual gift card, may be kept up-to-date as purchases are made.

In the distributor model, the provider of the virtual gift card platform may, instead of generating virtual gift card codes, receive virtual gift card codes from a retailer (or from a third-party generating codes on behalf of a retailer), either in blocks or individually when needed. Additionally, in the distributor model, the retailer may maintain its own database of virtual gift cards. In the distributor model, the provider of the virtual gift card platform may not need to be kept apprised of purchases by the virtual gift card recipient. In either model, information relating to gift card usage may be maintained, and offers may be made to gift card purchasers and/or recipients in real-time.

### Processor Model

As noted above, in the processor model the provider of a virtual gift card platform may provide the virtual gift card codes and maintain the database of recipient accounts. In embodiments, a purchaser may be redirected to a website of the provider of a virtual gift card platform from a website of the retailer at whose websites and/or stores the virtual gift card is redeemable. For example, a purchaser may click on an area of the retailer's website marked “get a virtual gift card” or similar and be redirected to a website of the provider.

The website of the provider may include an interface having fields into which the purchaser can enter information pertaining to the virtual gift card and to the recipient. In embodiments, the interface is customized with design elements particular to the retailer such as the retailer's logo or other design elements. Advantages of this feature include branding for the retailer and transparency for the purchaser. The retailer can redirect to the provider to handle providing the virtual gift card while maintaining its brand presence in front of the purchaser through the process. And the purchaser can retain the experience of shopping with a trusted retailer instead of being obviously redirected to a third-party website. In yet another embodiment, similar design interfaces may be used by the retailer to design layouts for offers that are presented to users.

The fields in the user interface may collect information from the purchaser such as a dollar amount of the virtual gift card and the name and/or email address of the recipient. The interface may provide the opportunity to select a background image for the virtual gift card. The background image may, in embodiments, be selected from a predetermined set of images presented to the purchaser, for example, images provided by the retailer when configuring the virtual gift card interface. The interface may, in embodiments, provide the purchaser the opportunity to upload his or her own image for use as the background, in addition to or instead of providing predetermined image choices. The interface may provide the purchaser the opportunity to select from a number of predetermined messages, such as “Happy Birthday!” or “Congratulations!” The interface may also provide the purchaser with a text field for optionally entering a personalized message for the recipient. For example, the interface may provide a text box into which the purchaser may type any desired text. The purchaser's text will be displayed on the virtual gift card sent to the recipient. In embodiments, there may be an upper limit on the number of characters (e.g., 90 characters) and/or the number of lines of text in the customized personal message. The upper limit may be desirable for practicality of implementation as well as to preserve design aspects of the virtual gift card.

In embodiments, the interface may show a preview of the completed virtual gift card with purchaser-selected or purchaser-created elements in place. In embodiments the interface may give the purchaser the opportunity to select other design elements of the virtual gift card, such as a picture background (either selected from a predetermined set or uploaded by the purchaser), text color, or other design elements. These design elements may also be displayed in the preview of the completed virtual gift card. The preview may be displayed in real-time, or upon input from the purchaser. In embodiments, the interface includes a two-pane presentation in which one pane includes fields for the purchaser to enter information and/or select design elements, and the other pane includes a display area for displaying a preview of the virtual gift card. This gives the purchaser the opportunity to readily visualize the virtual gift card prior to purchase.

For example, in embodiments, the interface provides for the purchaser to enter a personalized message of up to some predetermined number of characters. The personal message can be previewed on the virtual gift card as it is being written. In embodiments, the virtual gift card template may be specifically designed so that the personal message text can be displayed in a manner that does not conflict with the other design elements. The preview feature permits the purchaser to verify that the personal message text does not overlap or otherwise conflict with other design elements in the virtual gift card.

In embodiments, the interface may provide the purchaser an option for delivery of the virtual gift card immediately upon purchase or at a later date selected or otherwise entered by the purchaser into a delivery date field of the interface. The interface may also include fields for entering information about the purchaser, such as the purchaser's name and/or email address.

Once all of the elements of the virtual gift card have been selected and/or entered, the interface provides to the purchaser fields for entering payment information, such as credit card information. The system may charge the purchaser for the amount of the virtual gift card, and in embodiments may also include a fee or service charge. When payment has been approved, the system may send a confirmation message to the purchaser, for example as a webpage, an email message, or both.

In embodiments, the system generates a virtual gift card code that can be uniquely associated with the virtual gift card. The virtual gift code may be generated at any point in the process of creating the virtual gift card and associated with the recipient at any point in the process of creating the virtual gift card. In embodiments, virtual gift card codes are generated and stored for retrieval and assignment to a particular recipient virtual gift card during the process of creating a virtual gift card. In other embodiments, a virtual gift card code may be generated upon entry of the recipient's name, upon approval of the purchaser's payment for the virtual gift card, or at any other time during the process of generating a virtual gift card.

In embodiments, virtual gift card codes may be generated as follows. Code generation may begin with a sequence number beginning, for example, at 1, and incremented each time a code is generated, up to a maximum sequence number (i.e., 1 billion). The sequence number is multiplied by a large prime number. A unique and difficult-to-predict integer is obtained by taking the remainder of this product modulo the maximum sequence number. This approach guarantees unique numbering (up to the maximum sequence number), without any externally obvious pattern. In embodiments, the unique number may have prepended to it the provider's BIN (bank identifier number) or IIN (issuer identifier number). The resulting code may also have an additional digit appended to make the full number valid according to a checksum such as the Luhn algorithm. This final Luhn-compliant number is one embodiment of a code that may be used as a unique virtual gift card code, and assigned by the system to a recipient's virtual gift card. It should be understood that many other approaches to generating and/or validating a unique code for use as a virtual gift card code may be taken. Any other procedure for generating such a code may be used with the systems and methods described in this application.

In embodiments, the system may provide an application, such as a browser application, that the retailer may use to authorize use of the gift card at any time after payment has been approved.

In embodiments, once the payment has been approved a message is provided to the recipient notifying the recipient that a gift card has been purchased for him or her. Where the purchaser has selected the option of delivering the gift card at a later date, notice to the recipient may be deferred until that date. The notice to the recipient may be, for example, an email message identifying the retailer, the purchaser, and/or the amount of the gift card. Like the interface provided to the purchaser, the email message may include design elements consistent with the retailer's branding, such as a logo or other images, particular colors and/or typefaces associated with the retailer's trade dress, or any other design element desired by the retailer.

In embodiments, the recipient is provided with the virtual gift card code which, as noted above, was generated and/or assigned to the recipient's virtual gift card at some prior point. The virtual gift card code may be provided in the email to the recipient, either directly or encrypted. In embodiments the code may be provided alphanumerically, or in some encoded form such as a 1D or 2D bar code, or in both forms.

In further embodiments, the email to the recipient may include a link that the recipient may click on to view a webpage provided by the virtual gift card provider. The webpage likewise may include the a display of the recipient's virtual gift card code, either alphanumerically or in an encoded form such as a 1D- or 2D-bar code, or in both forms. The webpage provided to the recipient may include design elements consistent with the retailer's branding, such as a logo or other images, particular colors and/or typefaces associated with the retailer's trade dress, or any other design element desired by the retailer.

After receiving the email message containing the virtual gift card and/or viewing the web page containing the virtual gift card, the recipient may redeem the virtual gift card either in the retailer's on-line store or at the retailer's physical store locations. In embodiments, the email and/or the webpage provided to the recipient may include a link to the retailer's on-line store, where the recipient can enter the virtual gift card code to use the virtual gift card toward a purchase. To use the virtual gift card in a physical store location, the recipient may print out the email and/or the webpage and bring the printout to the physical store, where the recipient's virtual gift card code may be keyed (or, in embodiments in which the email or webpage includes a barcode, scanned) or otherwise entered into a computer which requests a debit from the recipient's virtual gift card of the amount of purchase.

As noted above, in the processor model, the database of virtual gift cards (and associated values) is maintained by the virtual gift card provider. Thus, whether the virtual gift card is redeemed via on-line purchase or via in-store purchase, the retailer's computer communicates with a computer of the virtual gift card provider with the purchase amount of the recipient's purchase. In embodiments, any aspects of the transaction may be handled by the provider's servers.

In embodiments, the recipient need not redeem the full value of the virtual gift card in a single purchase. Unused value is stored at the provider's server, and the recipient can view the status of his or her virtual gift card by logging into a management system operated by the virtual gift card provider. In embodiments, the recipient's virtual gift card is updated dynamically as purchased are made, and the recipient can access the database and dynamically view the current balance by accessing a web page provided by the virtual gift card provider. For example, in embodiments the recipient can visit the web page linked in the email received by the recipient. The link in that email may reference a dynamically-generated page containing information about the recipient's virtual gift card. For example, the link may include a field that is based upon the recipient's virtual gift card code, and pass that field to an application on the provider's server that dynamically generates a web page based upon the current status of the recipient's virtual gift card. If desired, the recipient can make additional purchases at a later date either using the virtual gift card code for an on line purchase, using the original printout with the code or bar code, or by creating a new virtual gift card printout reflecting the new balance at a future date.

In embodiments, the provider of the virtual gift card service can provide reporting based upon the virtual gift card database to the recipient, to the retailer, or both. For example, the provider can provide reporting of redemption statistics in real-time or over selected periods of time. The provider may also provide lift data indicating any increase in spending for the retailer's goods and/or services that can be attributed to the virtual gift card program over any time period. The provider may provide recency data showing a history of the most recent transactions (including purchase and/or redemption of virtual gift cards) over any time period. The provider can provide any other desired reporting that can be obtained from a database in which the times, amounts, and other data about virtual gift card purchase and redemption transactions are stored.

### Distributor Model

The principal difference between embodiments structured according to the processor model and those structured according to the distributor model is that in the distributor model, the virtual gift card codes are provided by the retailer (or by a third-party providing virtual gift card codes on behalf of the retailer).

The virtual gift card codes may be provided to the virtual gift card provider in a variety of ways. In embodiments, a block of virtual gift card codes may be stored in a database of the provider for issue (e.g., assignment to a particular virtual gift card) upon sale of a virtual gift card. In such embodiments, the retailer may generate a block of such virtual gift card codes itself, or obtain them from a third party. In the latter case the retailer may receive a block of codes from the third party and pass them to the virtual gift card provider or instruct the third party to provide the codes directly to the virtual gift card provider.

In other embodiments, the virtual gift card codes may be provided to the provider one at a time, when needed. For example, the provider can obtain one or more virtual gift card codes as-needed during the process of generating a virtual gift card via a system call that requests a virtual gift card code (or any needed number of virtual gift card codes) from the retailer or from the third-party providing codes on behalf of the retailer.

Additionally, in embodiments of the distributor model, rather than the provider maintaining a database of virtual gift cards, the retailer maintains its own database of recipient accounts (or, a third party maintains such a database on behalf of the retailer). In such embodiments, there may be no need to update the provider when a virtual gift card is redeemed or partially redeemed. Accordingly the provider may not be involved in any aspects of transactions involving the virtual gift card after the virtual gift card is purchased and delivered.

Apart from such back-end implementation details, however, a virtual gift card system according to the processor model may appear substantially the same to purchasers and recipients of virtual gift cards. Thus, in embodiments, the distributor model system can operate exactly as described above in connection with the processor model. All of the interfaces and features made available to the purchaser as described above may be implemented in embodiments of the distributor model as well. Likewise the interfaces and features made available to the recipient in the processor model described above can also be implemented in the distributor model. In embodiments in which the retailer operates its own recipient account database, however, the provider will not provide virtual gift card use data or statistics, and the recipient will not be able to view its redemption history, monitor balance information, or print out new virtual gift cards by viewing a webpage generated by the provider.

### Bulk Purchase System

At times it may be desirable to purchase multiple virtual gift cards simultaneously. For example, an employer wishing to purchase a gift card for every one of his employees may find it convenient to configure and pay for multiple gift cards in a single interface, rather than stepping through the entire configuration and payment process repeatedly. For this reason, a system for providing a virtual gift card may include an interface for configuring multiple gift cards at once. The purchaser may access such a bulk purchase interface by selecting an option within the virtual gift card purchase interface.

In embodiments, a bulk purchase interface may include fields in which the purchaser can enter denominations, recipient information, and/or customized messages for virtual gift cards any number of recipients. For example, the purchaser may select (or upload) a background image that will be used for all the bulk-purchased virtual gift cards and then enter denominations, recipient information, and/or customized messages for a plurality of recipients. In embodiments, the purchaser may be given the option to specify the same denomination and/or the same customized message for a plurality of recipients. In further embodiments, the interface may allow the purchaser to upload a text file, spreadsheet file, or similar file containing denominations, recipient information, and/or customized messages for any number of recipients, instead of entering such information by hand into the interface. In such embodiments the system may specify one or more acceptable file formats, e.g. comma-delimited text.

Once the purchaser has submitted information specifying the virtual gift card parameters for all of the bulk virtual gift card recipients, the purchaser can proceed to the payment interface as described above. The virtual gift card provider's system may generate and assign a unique virtual gift card code to each of the specified recipients (in a system according to the processor model) or assign from a database a unique virtual gift card code to each of the specified recipients (in a system according to the distributor model).

Once the bulk purchase is complete, the virtual gift cards generated for the multiple recipients may be handled individually as described above. For example, the virtual gift card provider's system may send an email to each virtual gift card recipient, the email including the corresponding virtual gift card code as assigned above. Each recipient may redeem his or her own virtual gift card in any of the ways described above, including by shopping on-line with his or her virtual gift card code, and/or bringing to a physical store location a printout of the email or of a webpage containing the virtual gift card in alphanumeric and/or bar code form. In embodiments, each individual recipient of a virtual gift card created as part of a bulk purchase can have access to dynamically updated information, as described above. Any other tracking or reporting that is possible for any virtual gift card system can also be implemented for virtual gift cards purchased in bulk.

Additionally, in embodiments, the purchaser of the bulk purchase of virtual gift cards may be provided, for example though a purchaser account at the provider's website, statistics relating to the bulk purchase. For example, the provider may provide access to data as to which or how many recipients have received, viewed, and/or used their virtual gift cards. Such data may be updated in real-time and dynamically accessed when the purchaser requests a report.

### Virtual Gift Card Template System

In embodiments, the virtual gift card provider may provide the retailer with an application that the retailer may use to design a template for virtual gift cards associated with the retailer. The application permits the retailer to specify one or more configurations of design elements of the virtual gift card. The application may be, for example, a browser application or a stand-alone application that runs on a computer of the retailer and sends the retailer-customized templates to the provider for use in providing virtual gift cards. An advantage of this feature is that the retailer can control aspects of the appearance of the virtual gift card, allowing the retailer to preserve its branding features (such as logo, typeface, design palate, &c.) even in virtual gift cards generated by the provider.

In embodiments, the application presents an interface to a designer acting on behalf of the retailer that the designer may use to specify design elements of the retailer's virtual gift cards. For example, the interface may permit the designer to specify one or more background images for the virtual gift cards, the size, color, and placement of any text elements on the virtual gift card, or any other design feature. The interface may offer the designer a preview of the virtual gift card template either in real time or in response to a request from the designer.

Once the virtual gift card template is completed, it can be implemented by the virtual gift card provider. The virtual gift card template may be presented to a virtual gift card purchaser through an interface such as those described above, where the purchaser can provide any remaining information needed or desired to complete the virtual gift card. The design template application may include fields allowing the designer to specify which elements of the design are fixed within the template and which are subject to further customization by a virtual gift card purchaser.

In embodiments, at least some design elements of the template may be specified by the designer such that a purchaser using an interface to purchase a virtual gift card may not be given the option to customize the design elements further. For example, the designer may specify that a logo of the retailer appear in a particular position on the virtual gift card, such that the purchaser does not have the option to remove the logo or move it to a different position on the gift card. As another example, the designer may specify that text on the virtual gift card appear in a particular size or particular color, such as a color associated with the retailer's trade dress.

In embodiments, at least some design elements of the template may be specified with the designer such that additional specification is left to a purchaser of a virtual gift card. For example, a designer may provide any number of background images that are stored in the template. These background images may be presented to the purchaser in the purchase interface so that the purchaser may select one for the virtual gift card. As another example, the designer may specify in the template that text on the virtual gift card appear in a particular color, but leave to the purchaser the exact content of the text, such as the recipient's name and/or a personalized message provided to the recipient. As another example, the designer may specify the location of text, such as the recipient's name, on the virtual gift card, but permit the purchaser to select the color and the content of the text.

In embodiments, after a virtual gift card template has been established and stored, a designer can edit the template at any time via the design template application. In embodiments the design template is stored in a database of the virtual gift card provider and can be updated at any time via the design template application. Updates to the design template may take effect immediately, and be reflected the next time the design template is accessed by a purchaser.

It should be understood that the invention is not limited to each of the embodiments described herein, but rather, various embodiments of the invention may be practiced alone or in combination with other embodiments.

Based on the foregoing disclosure, it should be apparent to one of ordinary skill in the art that the invention is not limited to a particular computer system platform, processor, operating system, network, or communication protocol. Also, it should be apparent that the present invention is not limited to a specific architecture or programming language.

Having now described some illustrative aspects of the invention, it should be apparent to those skilled in the art that the foregoing is merely illustrative and not limiting, having been presented by way of example only. While the bulk of this disclosure is focused on embodiments directed to virtual gift card systems, aspects of the present invention may be applied to other information domains, for instance, physical gift card offers and/or combination offers using coupon-based systems. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments.

What is claimed is:

1. A method for administering a virtual gift card, the method comprising acts of:
configuring, in an offer management system, one or more offer rules that define when an offer is presented to a user;
associating the one or more offer rules with a gift card; and
responsive to one or more actions by the user in relation to the gift card, the action triggering at least one of the one or more offer rules, extending an offer associated with the at least one of the one or more offer rules to the user.

2. The method according to claim 1, wherein the action comprises a purchaser purchasing the gift card.

3. The method according to claim 2, wherein the offer is extended to the purchaser of the gift card.

4. The method according to claim 2, wherein the offer is extended to a recipient of the gift card.

5. The method according to claim 1, wherein the gift card is a virtual gift card, and wherein the offer management system interfaces with a virtual gift card management system.

6. The method according to claim 1, wherein the action comprises a gift card recipient redeeming the gift card.

7. The method according to claim 5, further comprising acts of:
providing an interface to a terminal operated by a purchaser; the interface comprising fields for receiving a value and a recipient for the virtual gift card;
receiving from the terminal, in response to input from the purchaser, the value and the recipient for the virtual gift card;
generating a code for the virtual gift card;
sending a message to the recipient of the virtual gift card, the message including the code for the virtual gift card;
one or both of:
receiving, from a terminal operated by the recipient, a message including the code for the virtual gift card and an amount of a purchase; and
receiving, from a terminal operated by the retailer, a message including the code for the virtual gift card and an amount of a purchase; and
debiting, from an account associated with the recipient, the amount of the purchase.

8. The method according to claim 1, wherein the extended offer relates to at least one of a physical gift card, a virtual gift card and a coupon.

9. The method according to claim 1, further comprising an act of permitting, an administrator, within an interface of the offer system, to define at least one offer rule.

10. The method according to claim 9, further comprising an act of creating the at least one offer rule, and associating the at least one offer rule with a plurality of gift cards that were previously issued to gift card recipients.

11. The method according to claim 1, further comprising an act of monitoring, in real-time, redemption of the offer.

12. The method according to claim 11, further comprising an act of triggering another offer rule and extending another offer responsive to the act of monitoring redemption of the offer.

13. The method according to claim 11, further comprising an act of modifying the offer responsive to the act of monitoring redemption of the offer.

14. The method according to claim 1, further comprising an act of issuing, by the offer management system, a new gift card responsive to the one or more actions by the user in relation to the gift card.

15. The method according to claim 1, further comprising an act of modifying a value of the gift card responsive to one or more actions by the user in relation to the gift card.

16. The method according to claim 1, further comprising an act of associating a coupon with the gift card responsive to the one or more actions by the user in relation to the gift card.

17. The method according to claim 1, further comprising an act of modifying a transaction parameter associated with a transaction performed using the gift card by the user.

18. A computer readable medium having computer-readable instructions stored thereon that define instructions that, as a result of being executed by a computer, instruct the computer to perform a method for administering a virtual gift card, the method comprising the acts of:
configuring, in an offer management system, one or more offer rules that define when an offer is presented to a user;
associating the one or more offer rules with a gift card; and
responsive to one or more actions by the user in relation to the gift card, the action triggering at least one of the one or more offer rules, extending an offer associated with the at least one of the one or more offer rules to the user.

19. The computer readable medium of claim 18, wherein the action comprises a purchaser purchasing the gift card.

20. The computer readable medium of claim 19, wherein the offer is extended to the purchaser of the gift card.

21. The computer readable medium of claim 19, wherein the offer is extended to a recipient of the gift card.

22. The computer readable medium of claim 18, wherein the gift card is a virtual gift card, and wherein the offer management system interfaces with a virtual gift card management system.

23. The computer readable medium of claim 18, wherein the action comprises a gift card recipient redeeming the gift card.

24. The computer readable medium of claim 22, wherein the method further comprises acts of:
providing an interface to a terminal operated by a purchaser; the interface comprising fields for receiving a value and a recipient for the virtual gift card;
receiving from the terminal, in response to input from the purchaser, the value and the recipient for the virtual gift card;
generating a code for the virtual gift card;
sending a message to the recipient of the virtual gift card, the message including the code for the virtual gift card;
one or both of:
receiving, from a terminal operated by the recipient, a message including the code for the virtual gift card and an amount of a purchase; and
receiving, from a terminal operated by the retailer, a message including the code for the virtual gift card and an amount of a purchase; and
debiting, from an account associated with the recipient, the amount of the purchase.

25. The computer readable medium of claim 18, wherein the extended offer relates to at least one of a physical gift card, a virtual gift card and a coupon.

26. The computer readable medium of claim 18, further comprising an act of permitting, an administrator, within an interface of the offer system, to define at least one offer rule.

27. The computer readable medium of claim 26, further comprising an act of creating the at least one offer rule, and associating the at least one offer rule with a plurality of gift cards that were previously issued to gift card recipients.

28. The computer readable medium of claim 18, further comprising an act of monitoring, in real-time, redemption of the offer.

29. The computer readable medium of claim 28, further comprising an act of triggering another offer rule and extending another offer responsive to the act of monitoring redemption of the offer.

30. The computer readable medium of claim 28, further comprising an act of modifying the offer responsive to the act of monitoring redemption of the offer.

31. The computer readable medium of claim 18, further comprising an act of issuing, by the offer management system, a new gift card responsive to the one or more actions by the user in relation to the gift card.

32. The computer readable medium of claim 18, further comprising an act of modifying a value of the gift card responsive to one or more actions by the user in relation to the gift card.

33. The computer readable medium of claim 18, further comprising an act of associating a coupon with the gift card responsive to the one or more actions by the user in relation to the gift card.

34. The computer readable medium of claim 18, further comprising an act of modifying a transaction parameter associated with a transaction performed using the gift card by the user.

35. A system for administering a virtual gift card, the system comprising:
a configuration component configured to, in an offer management system, create one or more offer rules that define when an offer is presented to a user;
an associated component configured to associate the one or more offer rules with a gift card; and
a component configured to respond to one or more actions by the user in relation to the gift card, the action triggering at least one of the one or more offer rules, extending an offer associated with the at least one of the one or more offer rules to the user.

36. The system according to claim 35, wherein the action comprises a purchaser purchasing the gift card.

37. The system according to claim 36, wherein the offer is extended to the purchaser of the gift card.

38. The system according to claim 36, wherein the offer is extended to a recipient of the gift card.

39. The system according to claim 35, wherein the gift card is a virtual gift card, and wherein the offer management system interfaces with a virtual gift card management system.

40. The system according to claim 35, wherein the action comprises a gift card recipient redeeming the gift card.

41. The system according to claim 39, the system further comprising:
providing an interface component configured to provide a user to a terminal operated by a purchaser; the interface comprising fields for receiving a value and a recipient for the virtual gift card;
receiving from the terminal, in response to input from the purchaser, the value and the recipient for the virtual gift card;
a component adapted to generate a code for the virtual gift card;
a component adapted to send a message to the recipient of the virtual gift card, the message including the code for the virtual gift card;
wherein the system comprises one or both of:
a component adapted to receive, from a terminal operated by the recipient, a message including the code for the virtual gift card and an amount of a purchase; and
a component adapted to receive, from a terminal operated by the retailer, a message including the code for the virtual gift card and an amount of a purchase; and
a component adapted to debit, from an account associated with the recipient, the amount of the purchase.

42. The system according to claim 35, wherein the extended offer relates to at least one of a physical gift card, a virtual gift card and a coupon.

43. The system according to claim 35, further comprising a component that is adapted to permit an administrator, within an interface of the offer system, to define at least one offer rule.

44. The system according to claim 43, further comprising a component that is adapted to create the at least one offer rule, and associating the at least one offer rule with a plurality of gift cards that were previously issued to gift card recipients.

45. The system according to claim 35, further comprising a component that is adapted to monitor, in real-time, redemption of the offer.

46. The system according to claim 45, further comprising a component that is adapted to trigger another offer rule and extending another offer responsive to monitoring redemption of the offer.

47. The system according to claim 45, further comprising a component that is adapted to modify the offer responsive to monitoring redemption of the offer.

48. The system according to claim 35, further comprising a component that is adapted to issue, by the offer management system, a new gift card responsive to the one or more actions by the user in relation to the gift card.

49. The system according to claim 35, further comprising a component that is adapted to modify a value of the gift card responsive to one or more actions by the user in relation to the gift card.

50. The system according to claim 35, further comprising a component that is adapted to associate a coupon with the gift card responsive to the one or more actions by the user in relation to the gift card.

51. The system according to claim 35, further comprising a component that is adapted to modify a transaction parameter associated with a transaction performed using the gift card by the user.
